(19) United States
(12) Patent Application Publication
(10) Pub. No.: US 2006/0286479 A1
(43) Pub. Date: Dec. 21, 2006

(54) Toner for developing electrostatic latent image

(75) Inventor: Toyotsune Inoue, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/452,977

(22) Filed: Jun. 15, 2006

(30) Foreign Application Priority Data
Jun. 21, 2005 (JP) 2005-180915

(51) Int. Cl. G03G 9/087

(52) U.S. Cl. 430/109.4; 430/111.4

(57) ABSTRACT

A toner is provided, which is suitable for developing an electrostatic latent image in an image forming apparatus based on an electrophotographic method or an electrostatic recording method, and ensures low-temperature fixability while suppressing hot offset. The toner comprises a binder resin and a colorant. The binder resin comprises a urethane-modified polyester resin having a tetrahydrofuran insoluble content of not higher than 10% by weight. The toner has a melt viscosity η₉₅ of 1.0×10⁴ to 1.0×10⁶ Pas at 95° C. The toner has a ratio A (η₉₂/η₁₀₀) of a melt viscosity η₉₂ at 92° C. to a melt viscosity η₁₀₀ at 100° C. and a ratio B (η₁₀₀/η₁₁₀) of a melt viscosity η₁₀₀ at 100° C. to a melt viscosity η₁₁₀ at 110° C. which satisfy the following expression (i):
0.45<B/A<0.93 (i)

### BACKGROUND OF THE INVENTION

1. Field of the Invention

The present invention relates to a toner for developing an electrostatic latent image and, more specifically, a toner to be used for developing an electrostatic latent image in an image forming apparatus based on an electrophotographic method or an electrostatic recording method.

2. Description of the Related Art

Conventionally, polyester resins are widely used as a binder resin for a toner to be employed in an image forming apparatus based on an electrophotographic method or an electrostatic recording method.

The polyester resins are excellent in fixability at low temperatures, but susceptible to an offset phenomenon at high temperatures (hot offset).

In Japanese Unexamined Patent Publication No. 2002-91077 (JP-A-2002-91077), a toner is disclosed, which employs a polyester binder resin containing a component insoluble in tetrahydrofuran (THF) in a proportion of 10 to 60 mass % and having a melt viscosity (V₁₀₀) of 5×10⁴ to 1×10⁷ Pa·s at 100° C. and a melt viscosity change ratio V₁₀₀/V₁₄₀ of not higher than 10³ from 100° C. to 140° C. This toner is excellent in low-temperature fixability, and ensures energy saving of a fixing device and quick printing.

However, the toner disclosed in JP-A-2002-91077 is disadvantageously susceptible to the hot offset.

### SUMMARY OF THE INVENTION

It is an object of the present invention to provide a toner which is suitable for developing an electrostatic latent image in an image forming apparatus based on an electrophotographic method or an electrostatic recording method, and ensures the low-temperature fixability while suppressing the hot offset.

The inventive toner comprises a binder resin and a colorant, the binder resin comprising a urethane-modified polyester resin having a tetrahydrofuran insoluble content of not higher than 10% by weight, the toner having a melt viscosity η₉₅ of 1.0×10⁴ to 1.0×10⁶ Pa·s at 95±0.2° C., the toner having a ratio A (η₉₂/η₁₀₀) of a melt viscosity η₉₂ at 92±0.2° C. to a melt viscosity η₁₀₀ at 100±0.2° C. and a ratio B (η₁₀₀/η₁₁₀) of a melt viscosity η₁₀₀ at 100±0.2° C. to a melt viscosity η₁₁₀ at 110±0.2° C. which satisfy the following expression (i)
0.45<B/A<0.93 (i)

Like the prior art toner employing the polyester resin as the binder resin, the inventive toner is excellent in low-temperature fixability. In addition, the toner is excellent in high-temperature fixability. Therefore, the toner suppresses offset at low temperatures (cold offset) as well as the hot offset. That is, the inventive toner is excellent in fixability to a material onto which the toner is transferred and in releasability from contact-heat-fixing means such as a heat roller. With the use of the toner, it is possible to suppress the offset phenomena and a like fixing failure and to improve the quality of a formed image.

### DESCRIPTION OF PREFERRED EMBODIMENTS

The inventive toner contains a binder resin and a colorant. The binder resin contains a urethane-modified polyester resin having a tetrahydrofuran insoluble content of not higher than 10% by weight.

The urethane-modified polyester resin is a polyester resin having urethane bonds (—NHCOO—) in its molecule. The urethane-modified polyester resin is prepared, for example, by melt-kneading a blend of a polyester resin (preferably two or more types of polyester resins) and a diisocyanate-based compound to bond free OH groups in the polyester resin by the urethane bonds.

The polyester resin to be used for the preparation of the urethane-modified polyester resin is not particularly limited, but may be any of various polyester resins each prepared by reacting a polyvalent alcohol with a polyvalent carboxylic acid.

Examples of the polyvalent alcohol include glycol compounds (diols) such as diethylene glycol, neopentyl glycol, ethylene glycol (1,2-ethanediol), triethylene glycol, tetraethylene glycol, trimethylene glycol (1,3-propanediol), propylene glycol (1,2-propanediol), tetramethylene glycol (1,4-butanediol), 1,2-butylene glycol (1,2-butanediol), 1,3-butylene glycol (1,3-butanediol), pentamethylene glycol (1,5-pentanediol), dipropylene glycol, tripropylene glycol, polyethylene-glycol and polypropylene glycol, bisphenol compounds such as polyoxyethylene(2.2)-2,2-bis(4-hydroxyphenyl) propane and polyoxypropylene(2.2)-2,2-bis(4-hydroxyphenyl) propane, and triols such as trimethylolpropane, trimethylolethane and glycerin (1,2,3-propanetriol).

Examples of the polyvalent carboxylic acid include dicarboxylic acids such as terephthalic acid, isophthalic acid, phthalic acid, oxalic acid, malonic acid, succinic acid, glutaric acid, adipic acid, pimelic acid, suberic acid, azelaic acid and sebacic acid, and tricarboxylic acids such as trimellitic acid and trimesic acid.

For the purpose of adjusting the polymerization degree of the polyester resin, to be used for the preparation of the urethane-modified polyester resin a small amount of a monocarboxylic acid may be blended in addition to the polyvalent alcohol and the polyvalent carboxylic acid. Examples of the monocarboxylic acid include benzoic acid and trimellitic anhydride.

Examples of the diisocyanate-based compound include tolylene diisocyanates (toluene diisocyanate, 2,4-tolylene diisocyanate, 2,6-tolylene diisocyanate and the like), diphenylmethane diisocyanates (diphenylmethane-4,4′-diisocyanate and the like), 1-chloro-2,4-phenylene diisocyanate, o-, m- and p-phenylene diisocyanates, and 3,3′-dimethyl-4,4′-biphenylene diisocyanate.

Where the urethane-modified polyester resin is prepared by melt-kneading a blend of two or more types of polyester resins and the diisocyanate-based compound, the proportions of the two or more types of polyester resins are properly determined according to required characteristics of the urethane-modified polyester resin.

The proportion of the diisocyanate-based compound based on the total weight of the polyester resin(s) is not particularly limited, but preferably 1 to 10 parts by weight, more preferably 2 to 8 parts by weight, further more preferably 3 to 6 parts by weight, based on a total of 100 parts by weight of the polyester resin(s).

The THF insoluble content of the urethane-modified polyester resin, which is herein defined as the proportion of a resin component insoluble in THF based on the weight of the toner, is not higher than 10% by weight as described above. If the THF insoluble content of the urethane-modified polyester resin to be used as the binder resin of the toner is higher than 10% by weight, it is impossible to suppress the cold offset in an image formation process with the use of the resulting toner. The THF insoluble content of the urethane-modified polyester resin is preferably Power than 10% by weight, more preferably not higher than 9% by weight, further more preferably not higher than 5% by weight, in the aforesaid range.

In order to set the THF insoluble content of the urethane-modified polyester resin in the aforesaid range, the molecular weight of the urethane-modified polyester resin, the valences of the polyvalent alcohol and the polyvalent carboxylic acid for the preparation of the polyester resin and the shape of the molecular chain of the polyester resin (particularly, the proportion of a branched molecular structure), for example, are properly adjusted, though not limitative.

More specifically, the THF insoluble content of the urethane-modified polyester resin tends to be increased by increasing the molecular weight of the urethane-modified polyester resin and, conversely, tends to be reduced by reducing the molecular weight of the urethane-modified polyester resin.

Further, the THF insoluble content of the urethane-modified polyester resin tends to be increased by employing a polyvalent alcohol and a polyvalent carboxylic acid each having a higher valence for the preparation of the polyester resin and, conversely, tends to be reduced by employing a polyvalent alcohol and a polyvalent carboxylic acid each having a lower valence for the preparation of the polyester resin.

Furthermore, the THF insoluble content of the urethane-modified polyester resin tends to be increased as the proportion of the branched molecular structure in the polyester resin is increased and, conversely, tends to be reduced as the proportion of a linear molecular structure in the polyester resin is increased.

A resin to be contained in the binder resin in addition to the urethane-modified polyester resin having a THF insoluble content of not higher than 10% by weight is not particularly limited, but any of binder resins conventionally used for toners may be used. Particularly, the additional resin preferably has an excellent compatibility with the urethane-modified polyester resin having a THF insoluble content of not higher than 10% by weight, and specific examples thereof include polyester resins (e.g., polyethylene terephthalate, polybutylene terephthalate and the like), styrene resins (e.g., polystyrene and the like), olefin resins (e.g., polyethylene, polypropylene and the like) and polyamide resins, which have no urethane bond in their molecules. These resins may be used either alone or in combination.

In order to ensure the low-temperature fixability of the toner in the image forming process and suppress the hot offset; the proportion of the urethane-modified polyester resin having a THF insoluble content of not higher than 10% by weight in the binder resin is preferably not less than 60% by weight, more preferably not less than 80% by weight, further more preferably 100% by weight based on the binder resin.

The colorant is not particularly limited, but any of colorants commonly used for black toners and color toners may be herein used. Specific examples of the colorant include carbon black, aniline blue, carcoil blue, chrome yellow, ultramarine blue, Du Pont oil red, quinoline yellow, methylene blue chloride, copper phthalocyanine, malachite green oxalate, lamp black, rose bengal, carmine 6B, C.I. pigment red 48:1, C.I. pigment red 122, C.I. pigment red 57:1, C.I. pigment red 184, C.I. pigment yellow 97, C.I. pigment yellow 12, C.I. pigment yellow 17, C.I. pigment yellow 74, C.I. solvent yellow 162, C.I. pigment yellow 180, C.I. pigment yellow 185, C.I. pigment blue 15:1 and C.I. pigment 15:3.

The content of the colorant is not particularly limited but, for example, preferably 1 to 10 parts by weight, more preferably 2 to 6 parts by weight, based on 100 parts by weight of the binder resin.

In addition to the binder resin and the colorant, various additives such as a charge controlling agent (or a charge controlling resin), a releasing agent and magnetic particles may be added to the toner.

The charge controlling agent is not particularly limited, but either a negative charge controlling agent or a positive charge controlling agent may be employed as the charge controlling agent.

Examples of the negative charge controlling agent include boron complex compounds (e.g., boron-containing benzilic acid complexes and the like) metal-containing salicylic acid compounds, metal-containing monoazo compounds, metal-containing acetylacetone compounds, aromatic hydroxycarboxylic acids and metal salts thereof, aromatic monocarboxylic acids and metal salts thereof, aromatic polycarboxylic acids and metal salts thereof, phenol compounds (e.g., bisphenol and the like), urea compounds, metal-containing naphthoic acid compounds, quaternary ammonium salts, calixarene compounds, silicon compounds, styrene-acrylic acid copolymers, styrene-methacrylic acid copolymers, styrene-acrylic acid-sulfonic acid copolymers and metal-free carboxylic acid compounds, among which the boron complex compounds, the metal-containing salicylic acid compounds and the calixarene compounds are preferred in terms of electrical conductivity and tint.

Examples of the positive charge controlling agent include quaternary ammonium salts such as salts of tributylbenzylammonium-1-hydroxy-4-naphthosulfonic acid and tetrabutylammonium tetrafluoroborate, nigrosine pigments, metal salts of, fatty acids, guanidine compounds, imidazole compounds, onium salts such as phosphonium salts and lake pigments containing any of these onium salts, triphenylmethane dyes and lake pigments containing any of these triphenylmethane dyes, metal salts of higher fatty acids, diorgano tin oxides such as dibutyl tin oxide, dioctyl tin oxide and dicyclohexyl tin oxide. Exemplary laking agents for forming the lake pigments include phosphotungstic acid, phosphomolybdic acid, phosphotungstomolybdic acid, tannic acid, lauric acid, gallic acid, ferricyanic compounds and ferrocyanic compounds.

The charge controlling resin is not particularly limited, but examples thereof include copolymers of an ionic monomer such as an ammonium salt having an ionic functional group (e.g., N,N-diethyl-N-methyl-2-(methacryloyloxy)ethylammonium p-toluenesulfonate) and a monomer (e.g., a styrene monomer or an acrylic monomer) that is copolymerizable with the ionic monomer.

The content of the charge controlling agent or the charge controlling resin is not particularly limited, but is preferably 0.1 to 10 parts by weight, more preferably 1.0 to 5.0 parts by weight based on 100 parts by weight of the binder resin.

The releasing agent is not particularly limited, but examples thereof include polyethylene wax, polypropylene wax, carnauba wax, rice wax, sasol wax, montan ester wax, montan wax and Fischer-Tropsch wax. The content of the releasing agent is not particularly limited, but is preferably 0.5 to 5 parts by weight, more preferably 0.7 to 2.5 parts by weight, based on 100 parts by weight of the binder resin.

The magnetic particles are not particularly limited, but examples thereof include ferrite particles, magnetite particles and iron particles.

The toner is prepared by blending the binder resin and the colorant and, as required, any of the additives including the charge controlling agent (or the charge controlling resin), the releasing agent and the magnetic particles, melt-kneading the resulting blend, and pulverizing the kneaded product. As required, the pulverized product may be mixed with an external additive by stirring.

The external additive is not particularly limited, but may be an additive for adjusting the fluidity of the toner. Specific examples of the external additive include fine particles such as of silica, alumina and titanium oxide.

For the preparation of the toner, more specifically, a bled obtained by blending the binder resin and the colorant and, as required, any of the additives including the charge controlling agent (or the charge controlling resin), the releasing agent and the like is first mixed and stirred by a mixer (e.g., Henschel mixer or the like), and then melt-kneaded by a kneader (e.g., a twin screw extruder or the like). Subsequently, the resulting melt-kneaded product is pulverized on two or more steps, for example, including a coarse pulverization step and a fine pulverization step.

For the coarse pulverization of the melt-kneaded product, a crusher or a pulverizer such as a ball mill, a vibration mill, a jet mill or a pin mill is used. For the fine pulverization of the melt-kneaded product, an impact pneumatic pulverizer, for example, is used.

The particle diameter of the toner prepared through the pulverization steps is not particularly limited, because the particle diameter depends upon the application of the toner. For example, the toner preferably has an average particle diameter of 3 to 15 μm, more preferably 5 to 10 μm, as measured by a particle size distribution measurement apparatus based on the Coulter Principle (e.g., a MULTISIZER™-series precision particle size distribution measurement apparatus available from Beckman Coulter Inc.).

The inventive toner has a melt viscosity η₉₅ of 1.0×10⁴ to 1.0×10⁶ Pa·s at 95° C. (±0.2° C.), and a ratio A (η₉₂/η₁₀₀) of a melt viscosity η₉₂ at 92° C. (±0.2° C.) to a melt viscosity η₁₀₀ at 100° C. (±0.2° C.) and a ratio B (η₁₀₀/η₁₁₀) of a melt viscosity η₁₀₀ at 100° C. (±0.2° C.) to a melt viscosity η₁₁₀ at 110° C. (±0.2° C.) satisfy the following expression (i)
0.45<B/A<0.93 (i)

The melt viscosity of the toner is measured, for example, by means of a flow characteristic measuring device such as a flow tester (more specifically, for example, a flow tester of “CFT series” available from Shimadzu Corporation).

In the present invention, the temperatures of the measurement of the melt viscosity η each have a tolerance of ±0.2° C. The temperatures of the measurement of the melt viscosity η will hereinafter be described without their tolerances particularly specified.

The melt viscosity η₉₅ of the toner at 95° C. is 1.0×10⁴ to 1.0×10⁶ Pa·s. If the melt viscosity η₉₅ of the toner is lower than 1.0×10⁴ Pa·s, the occurrence of the hot offset will be remarkable. If the melt viscosity η₉₅ of the toner is higher than 1.0×10⁶ Pa·s, the occurrence of the low-temperature offset (cold offset) will be remarkable.

The melt viscosity η₉₅ of the toner is preferably 2.0×10⁴ to 8.0×10⁵ Pa·s, more preferably 5.0×10⁴ to 5.0×10⁵ Pa·s.

Proper adjustment of the melt viscosity η of the toner is achieved, for example, by adjusting the proportion of the diisocyanate component in the urethane-modified polyester resin, or adjusting the valences and molecular weights of the polyvalent alcohol and the polyvalent carboxylic acid for the preparation of the polyester resin, though not limitative.

More specifically, the melt viscosity η of the toner tends to be increased by increasing the proportion of the diisocyanate component in the urethane-modified polyester resin and, conversely, tends to be reduced by reducing the proportion of the diisocyanate component in the urethane-modified polyester resin.

Further, the melt viscosity η of the toner tends to be increased by employing a higher valence alcohol and a higher valence carboxylic acid for the preparation of the polyester resin and, conversely, tends to be reduced by employing a lower valence alcohol and a lower valence carboxylic acid.

Furthermore, the melt viscosity η of the toner tends to be increased by employing a higher molecular weight polyvalent alcohol and a higher molecular weight polyvalent carboxylic acid for the preparation of the polyester resin and, conversely, tends to be reduced by employing a lower molecular weight polyvalent alcohol and a lower molecular weight polyvalent carboxylic acid.

As described above, the ratio B/A between the ratio B (η₁₀₀/η₁₁₀) of the melt viscosity η₁₀₀ at 100° C. to the melt viscosity η₁₁₀ at 110° C. and the ratio A (η₉₂/η₁₀₀) of the melt viscosity η₉₂ at 92° C. to the melt viscosity η₁₀₀ at 100° C. falls within the range specified by the expression (i) described above.

For the measurement of the melt viscosity η, temperatures of 92° C., 110° C. and 100° C. are selected to define a melt starting temperature, a melt ending temperature and a viscosity changing temperature, respectively, when the toner is heated.

The ratio A (η₉₂/η₁₀₀) of the melt viscosity η₉₂ at 92° C. to the melt viscosity η₁₀₀ at 100° C. and the ratio B (η₁₀₀/η₁₁₀) of the melt viscosity η₁₀₀ at 100° C. to the melt viscosity η₁₁₀ at 110° C. each have a positive value, and differences (Δη) between the melt viscosities η₉₂ and η₁₀₀ and between the melt viscosities η₁₀₀ and η₁₁₀ are increased as the absolute values of the ratio A and the ratio B increase. That is, when the ratio A or the ratio B has a greater absolute value, the average change ratio of the melt viscosity η is greater in a temperature range from 92° C. to 100° C. or in a temperature range from 100° C. to 110° C.

The ratio A and the ratio B each have a positive value, and the differences (Δη) between the melt viscosities η₉₂ and η₁₀₀ and between the melt viscosities η₁₀₀ and η₁₁₀ are reduced as the absolute values of the ratio A and the ratio B decrease. That is, when the ratio A or the ratio B has a smaller absolute value, the average change ratio of the melt viscosity η is smaller in the temperature range from 92° C. to 100° C. or in the temperature range from 100° C. to 110° C.

The ratio A is an index that influences the degree of the hot offset, and the ratio B is an index that influences the degree of the cold offset.

When the ratio B/A (i.e., (η₁₀₀/η₁₁₀)/(η₉₂/η₁₀₀)) is 1 (i.e., (η₁₀₀/η₁₁₀)=(η₉₂/η₁₀₀)), the average change ratio of the melt viscosity η in the temperature range from 92° C. to 100° C. is equal to the average change ratio of the melt viscosity η in the temperature range from 100° C. to 110° C. The ratio B/A has a positive value, and the average change ratio of the melt viscosity η in the temperature range from 100° C. to 110° C. is smaller than the average change ratio of the melt viscosity η in the temperature range from 92° C. to 100° C. when the ratio B/A has a smaller absolute value.

As described above, the ratio B/A of the toner is in a range greater than 0.45 and smaller than 0.93. Where the ratio B/A falls within this range, it is possible to improve the fixability and the releasability while suppressing the occurrence of the hot offset and the cold offset. If the ratio B/A is not greater than 0.45, the occurrence of the cold offset will be remarkable. Conversely, if the ratio B/A is not smaller than 0.93, the fixability and the releasability will be remarkably deteriorated.

In the aforesaid range, the ratio B/A is preferably greater than 0.60 and smaller than 0.92. That is, the ratio B/A preferably satisfies the following expression (ii):
0.60<B/A<0.92 (ii)

The melt viscosity η₉₂ of the toner at 92° C. is determined according to the ratio A (η₉₂/η₁₀₀) and a required value of the ratio B/A. Therefore, the range of the value of η₉₂ per se is not particularly limited, but preferably 1.0×10⁴ to 1.5×10⁶ Pa·s for ensuring the fixability in the image formation process and suppressing the occurrence of the offset phenomena.

The melt viscosity η₁₀₀ of the toner at 100° C. is determined according to the ratio A, the ratio B (η₁₀₀/η₁₁₀) and the required value of the ratio B/A. Therefore, the range of the value of η₁₀₀ per se is not particularly limited, but preferably 4.0×10³ to 3.5×10⁵ Pa·s.

The melt viscosity η₁₁₀ polo of the toner at 110° C. is determined according to the ratio B and the required value of the ratio B/A. Therefore, the range of the value of η₁₁₀ per se is not particularly limited, but preferably 1.5×10³ to 1.5×10⁵ Pa·s.

The ratio A (η₉₂/η₁₀₀) of the melt viscosity η₉₂ of the toner at 92° C. to the melt viscosity η₁₀₀ of the toner at 100° C. is determined according to the relation with the ratio B. Therefore, the range of the value of the ratio A per se is not particularly limited, but preferably 3.0 to 4.8.

The ratio B (η₁₀₀/η₁₁₀) of the melt viscosity η₁₀₀ of the toner at 100° C. to the melt viscosity η₁₁₀ of the toner at 110° C. is determined according to the relation with the ratio A. Therefore, the range of the value of the ratio B per se is not particularly limited, but preferably 1.8 to 4.0.

### EXAMPLES

The present invention will hereinafter be described by way of examples in conjunction with comparative examples, but it should be understood that the invention be not limited to the following examples.

Preparation of Polyester Resins

Preparation 1

Diethylene glycol (DEG) and neopentyl glycol (NPG) were blended in a molar ratio of DEG:NPG=57:43, and terephthalic acid (TPA) was blended with the resulting blend. The blend ratio of TPA was adjusted to a molar ratio of 98 based on a total of 100 of DEG and NPG. In turn, 0.2 parts by weight of tetra(2-ethylhexyl) titanate was blended with 100 parts by weight of the blend of DEG, NPG and TPA. The resulting blend was reacted in a nitrogen atmosphere at 250° C. for polycondensation. Thus, a polyester resin P-1 was prepared.

Preparation 2

DEG, NPG and trimethylol propane (TMP) were blended in a molar ratio of DEG:NPG:TMP=55:43:2, and TPA was blended with the resulting blend. The blend ratio of TPA was adjusted to a molar ratio of 98 based on a total of 100 of DEG, NPG and TMP. In turn, 0.2 parts by weight of tetra(2-ethylhexyl) titanate was blended with 100 parts by weight of the blend of DEG, NPG, TMP and TPA. The resulting blend was reacted in a nitrogen atmosphere at 250° C. for polycondensation. Thus, a polyester resin P-2 was prepared.

Preparation 3

A polyester resin P-3 was prepared in substantially the same manner as in Preparation 2, except that DEG, NPG and TMP were blended in a molar ratio of DEG:NPG:TMP=54:43:3.

Preparation 4

A polyester resin P-4 was prepared in substantially the same manner as in Preparation 2, except that DEG, NPG and TMP were blended in a molar ratio of DEG:NPG:TMP=49:43:8.

Preparation 5

A polyester resin P-5 was prepared in substantially the same manner as in Preparation 2, except that DEG, NPG and TMP were blended in a molar ratio of DEG:NPG:TMP=47:43:10.

Preparation 6

A polyester resin P-6 was prepared in substantially the same manner as in Preparation 2, except that DEG, NPG and TMP were blended in a molar ratio of DEG:NPG:TMP=45:43:12.

Preparation 7

A polyester resin P-7 was prepared in substantially the same manner as in Preparation 2, except that DEG, NPG and TMP were blended in a molar ratio of DEG:NPG:TMP=44:43:13.

Preparation 8

A polyester resin P-8 was prepared in substantially the same manner as in Preparation 2, except that DEG, NPG and TMP were blended in a molar ratio of DEG:NPG:TMP=42:43:15.

Preparation 9

DEG, TPA and benzoic acid (BA) were blended in a molar ratio of DEG:TPA:BA=100:98:9, and 0.2 parts by weight of tetra (2-ethylhexyl) titanate was blended with 100 parts by weight of the resulting blend. In turn, the resulting blend was reacted in a nitrogen atmosphere at 250° C. for polycondensation. Thus, a polyester resin P-9 was prepared.

The blend ratios of DEG, NPG and TMP (molar ration DEG:NPG:TMP) and the blend ratio (molar ratio) of TPA and BA based on a total of 100 of DEG, NPG and TMP in the polyester resins P-1 to P-9 prepared in Preparations 1 to 9 are shown in Table 1.

TABLE 1
POLYESTER RESINS

| | | |
|---|---|---|
| | Blend ratio | Blend ratio |
| Resin | (molar ratio) | (molar ratio) |

| Preparation | No. | DEG:NPG:TMP | TPA | BA |
|---|---|---|---|---|
| 1 | P-1 | 57:43:0 | 98 | — |
| 2 | P-2 | 55:43:2 | 98 | — |
| 3 | P-3 | 54:43:3 | 98 | — |
| 4 | P-4 | 49:43:8 | 98 | — |
| 5 | P-5 | 47:43:10 | 98 | — |
| 6 | P-6 | 45:43:12 | 98 | — |
| 7 | P-7 | 44:43:13 | 98 | — |
| 8 | P-8 | 42:43:15 | 98 | — |
| 9 | P-9 | 100:0:0 | 98 | 9 |

Preparation 10

Polyoxypropylene(2.2)-2,2-bis (4-hydroxyphenyl)propane (PO-BPA), polyoxyethylene(2.2)-2,2-bis(4-hydroxyphenyl)propane (EO-BPA), TPA and trimellitic anhydride (TMA) were blended in a molar ratio of PO-BPA:EO-BPA:TPA:TMA=40:10:40:10, and 4 parts by weight of bis(tributyltin) oxide (TBTO, C₂₄H₅₄OSn₂) was blended with 100 parts by weight of the resulting blend. Then, the resulting blend was reacted in a nitrogen atmosphere at 230° C. for polycondensation. Thus, a polyester resin P-10 was prepared.

Preparation 11

PO-BPA, EO-BPA, TPA and TMA were blended in a molar ratio of PO-BPA:EO-BPA:TPA:TMA=35:10:40:15, and 4 parts by weight of TBTO was blended with 100 parts by weight of the resulting blend. Then, the resulting blend was reacted in a nitrogen atmosphere at 230° C. for polycondensation. Thus, a polyester resin P-11 was prepared.

The blend ratios of PO-BPA, EO-BPA, TPA and TMA (molar ratios PO-BPA:EO-BPA:TPA:TMA) in the polyester resins P-10 and P-11 prepared in Preparations 10 and 11 are shown in Table 2.

TABLE 2
POLYESTER RESINS

| | | Blend ratio (molar ratio) |
|---|---|---|
| Preparation | Resin No. | PO-BPA:EO-BPA:TPA:TMA |
| 10 | P-10 | 40:10:40:10 |
| 11 | P-11 | 35:10:40:15 |

Preparation of Urethane-Modified Polyester Resins
Preparation 12

The polyester resin P-1 prepared in Preparation 1 and the polyester resin P-9 prepared in Preparation 9 were blended in a weight ratio of 20:80, and 1.0 part by weight of tolylene diisocyanate (TDI) was blended with 100 parts by weight of the resulting blend. In turn, the resulting blend was charged into a twin screw extruder (PCM30 available from Ikegai Corp. and having a screw diameter of 30 mm), and melt-kneaded at 180° C. at a rotation speed of 270 rpm. Thus, a urethane-modified polyester resin U-1 was prepared.

Preparation 13

The polyester resin P-2 prepared in Preparation 2 and the polyester resin P-9 prepared in Preparation 9 were blended in a weight ratio of 20:80, and 2.2 parts by weight of TDI was blended with 100 parts by weight of the resulting blend. In turn, the resulting blend was charged into the twin screw extruder PCM30, and melt-kneaded at 180° C. at a rotation speed of 270 rpm. Thus, a urethane-modified polyester resin U-2 was prepared.

Preparation 14

A urethane-modified polyester resin U-3 was prepared in substantially the same manner as in Preparation 13, except that the polyester resin P-4 prepared in Preparation 4 was used instead of the polyester resin P-2.

Preparation 15

A urethane-modified polyester resin U-4 was prepared in substantially the same manner as in Preparation 13, except that the polyester resin P-8 prepared in Preparation 8 was used instead of the polyester resin P-2.

Preparation 16

The polyester resin P-1 and the polyester resin P-9 were blended in a weight ratio of 20:80, and 3.3 parts by weight of TDI was blended with 100 parts by weight of the resulting blend. In turn, the resulting blend was charged into the twin screw extruder PCM30, and melt-kneaded at 180° C. at a rotation speed of 270 rpm. Thus, a urethane-modified polyester resin U-5 was prepared.

Preparation 17

A urethane-modified polyester resin U-6 was prepared in substantially the same manner as in Preparation 16, except that the polyester resin P-3 prepared in Preparation 3 was used instead of the polyester resin P-1.

Preparation 18

A urethane-modified polyester resin U-7 was prepared in substantially the same manner as in Preparation 16, except that the polyester resin P-7 prepared in Preparation 7 was used instead of the polyester resin P-1.

Preparation 19

The polyester resin P-4 and the polyester resin P-9 were blended in a weight ratio of 20:80, and 4.4 parts by weight of TDI was blended with 100 parts by weight of the resulting blend. In turn, the resulting blend was charged into the twin screw extruder PCM30, and melt-kneaded at 180° C. at a rotation speed of 270 rpm. Thus, a urethane-modified polyester resin U-8 was prepared.

Preparation 20

The polyester resin P-6 prepared in Preparation 6 and the polyester resin P-9 prepared in Preparation 9 were blended in a weight ratio of 20:80, and 6.0 parts by weight of TDI was blended with 100 parts by weight of the resulting blend. In turn, the resulting blend was charged into the twin screw-extruder PCM30, and melt-kneaded at 180° C. at a rotation speed of 270 rpm. Thus, a urethane-modified polyester resin U-9 was prepared.

Preparation 21

The polyester resin P-5 prepared in Preparation 5 and the polyester resin P-9 prepared in Preparation 9 were blended in a weight ratio of 20:80, and 8.0 parts by weight of TDI was blended with 100 parts by weight of the resulting blend. In turn, the resulting blend was charged into the twin screw extruder PCM30, and melt-kneaded at 180° C. at a rotation speed of 270 rpm. Thus, a urethane-modified polyester resin U-10 was prepared.

Preparation 22

The polyester resin P-4 and the polyester resin P-9 were blended in a weight ratio of 20:80, and 10.0 parts by weight of TDI was blended with 100 parts by weight of the resulting blend. In turn, the resulting blend was charged into the twin screw extruder PCM30, and melt-kneaded at 180° C. at a rotation speed of 270 rpm. Thus, a urethane-modified polyester resin U-11 was prepared.

The types of the two polyester resins, the blend ratio (weight ratio) of the two polyester resins and the blend ratio (parts by weight) of TDI based on 100 parts by weight of the blend of the two polyester reins in each of the urethane-modified polyester resins U-1 to U-11 are shown in Table 3.

TABLE 3
URETHANE-MODIFIED POLYESTER RESINS

| | | Polyester | | | | |
|---|---|---|---|---|---|---|
| | | resin 1 | | Polyester resin 2 | | Content of |
| | Resin | | Content | | Content | TDI (parts |
| Preparation | No. | Type | (Wt %) | Type | (Wt %) | by weight) |
| 12 | U-1 | P-1 | 20 | P-9 | 80 | 1.0 |
| 13 | U-2 | P-2 | 20 | P-9 | 80 | 2.2 |
| 14 | U-3 | P-4 | 20 | P-9 | 80 | 2.2 |
| 15 | U-4 | P-8 | 20 | P-9 | 80 | 2.2 |
| 16 | U-5 | P-1 | 20 | P-9 | 80 | 3.3 |
| 17 | U-6 | P-3 | 20 | P-9 | 80 | 3.3 |
| 18 | U-7 | P-7 | 20 | P-9 | 80 | 3.3 |
| 19 | U-8 | P-4 | 20 | P-9 | 80 | 4.4 |
| 20 | U-9 | P-6 | 20 | P-9 | 80 | 6.0 |
| 21 | U-10 | P-5 | 20 | P-9 | 80 | 8.0 |
| 22 | U-11 | P-4 | 20 | P-9 | 80 | 10.0 |

Preparation of Toners

### Example 1

First, 100 parts by weight of the urethane-modified polyester resin U-2 prepared in Preparation 13, 5 parts by weight of carbon black (MA100 available from Mitsubishi Chemical Corporation), 5 parts by weight of a charge controlling agent (FCA201PS available from Fujikura Kasei Co., Ltd.) and 4 parts by weight of a wax (U-MEX-110TS available from Sanyo Chemical Industries Ltd.) were mixed by stirring by means of a Henschel mixer, and melt-kneaded by means of a twin screw extruder. In turn, the resulting melt-kneaded product was coarsely pulverized, and further finely pulverized by means of an impact pneumatic pulverizer. Thus, toner particles having an average particle diameter of 9 μm were prepared.

Further, 100 parts by weight of the toner particles and 0.5 parts by weight of fine silica particles (RA200HS available from Nippon Aerojil Co., LTD. and having a primary particle diameter of 12 nm) were blended, and mixed by stirring by means of a Henschel mixer. Thus, a toner was prepared.

### Example 2

A toner was prepared in substantially the same manner as in Example 1, except that 100 parts by weight of the urethane-modified polyester resin U-3 prepared in Preparation 14 was used instead of the urethane-modified polyester resin U-2.

### Example 3

A toner was prepared in substantially the same manner as in Example 1, except that 100 parts by weight of the urethane-modified polyester resin U-6 prepared in Preparation 17 was used instead of the urethane-modified polyester resin U-2.

### Example 4

A toner was prepared in substantially the same manner as in Example 1, except that 100 parts by weight of the urethane-modified polyester resin U-7 prepared in Preparation 18 was used instead of the urethane-modified polyester resin U-2.

### Example 5

A toner was prepared in substantially the same manner as in Example 1, except that 100 parts by weight of the urethane-modified polyester resin U-8 prepared in Preparation 19 was used instead of the urethane-modified polyester resin U-2.

### Comparative Example 1

A toner was prepared in substantially the same manner as in Example 1, except that 100 parts by weight of the urethane-modified polyester resin U-1 prepared in Preparation 12 was used instead of the urethane-modified polyester resin U-2.

### Comparative Example 2

A toner was prepared in substantially the same manner as in Example 1, except that 100 parts by weight of the urethane-modified polyester resin U-4 prepared in Preparation 15 was used instead of the urethane-modified polyester resin U-2.

### Comparative Example 3

A toner was prepared in substantially the same manner as in Example 1, except that 100 parts by weight of the urethane-modified polyester resin U-5 prepared in Preparation 16 was used instead of the urethane-modified polyester resin U-2.

### Comparative Example 4

A toner was prepared in substantially the same manner as in Example 1, except that 100 parts by weight of the urethane-modified polyester resin U-9 prepared in Preparation 20 was used instead of the urethane-modified polyester resin U-2.

### Comparative Example 5

A toner was prepared in substantially the same manner as in Example 1, except that 100 parts by weight of the urethane-modified polyester resin U-10 prepared in Preparation 21 was used instead of the urethane-modified polyester resin U-2.

### Comparative Example 6

A toner was prepared in substantially the same manner as in Example 1, except that 100 parts by weight of the urethane-modified polyester resin U-11 prepared in Preparation 22 was used instead of the urethane-modified polyester resin U-2.

### Comparative Example 7

A toner was prepared in substantially the same manner as in Example 1, except that 100 parts by weight of the urethane-modified polyester resin P-10 prepared in Preparation 10 was used instead of the urethane-modified polyester resin U-2.

### Comparative Example 8

A toner was prepared in substantially the same manner as in Example 1, except that 100 parts by weight of the urethane-modified polyester resin P-11 prepared in Preparation 11 was used instead of the urethane-modified polyester resin U-2.

Measurement of Physical Properties of Toners

(1) Measurement of THF Insoluble Content

First, 1.0 g (W₁) of each of the toners prepared in Examples 1 to 5 and Comparative Examples 1 to 8 was weighed, and dissolved in 200 mL of THF by stirring for 12 hours. In turn, a residue (insoluble portion) of the toner in THF was dried at 100° C. in vacuum for two hours, and then weighed (W₂). The THF insoluble content was calculated from the following expression:

THF insoluble content (Wt %)=W₂/W₂×100

(2) Measurement of Melt Viscosity η

The melt viscosity η (Pa·s) of each of the toners prepared in Examples 1 to 5 and Comparative Examples 1 to 8 was measured by means of a flow tester (CFA-500 Model-A available from Shimadzu Corporation). In the measurement, a 1 mm×1 mm die was used under the following measurement conditions: a load of 30 kg, a temperature increasing rate of 4° C./min and a sample weight of 2.0 g.

The measurement of the melt viscosity η of each of the toners was performed at four temperatures, i.e., at 92° C., 95° C., 100° C. and 110° C. The tolerance of each of the measurement temperatures was ±0.2° C.

Evaluation of Toners

(1) Cold Offset and Hot Offset

An image output test was performed with the use of each of the toners prepared in Examples 1 to 5 and Comparative Examples 1 to 8 by means of an electrostatic-type copier (FS-8008 available from Kyocera Mita Corporation).

In the image output test, the fixing temperature (the surface temperature of a fixing roller of the copier) was set in two ways, i.e., at 140° C. and at 200° C. At the respective fixing temperatures, a solid image formation process (for forming a solid image on plain paper sheets with a margin of 4 mm left along four sides of each of the sheets) was performed five times. Then, the sheets each formed with the solid image at a fixing temperature of 140° C. were visually inspected to check for an offset phenomenon at 140° C. (cold offset), and the sheets each formed with the solid image at a fixing temperature of 200° C. were visually inspected to check for an offset phenomenon at 200° C. (hot offset).

In the evaluation of the toners for the offset phenomena, a toner was rated at A (excellent) where adherence of the toner on the fixing roller surface was not observed at all. A toner was rated at B (good) where slight adherence of the toner was observed with no practical problem. A toner was rated at C (unacceptable) where remarkable adhesion of the toner was observed.

(2) Fixability and Releasability

With the use of each of the toners prepared in Examples 1 to 5 and Comparative Examples 1 to 8, the solid image formation process (for forming a solid image on plain paper sheets with a margin of 4 mm left along four sides of each of the sheets) was performed 75 times by means of the electrostatic-type copier (FS-8008) with the fixing temperature (the surface temperature of the fixing roller) kept at 170° C.

After 75 cycles of the image formation process, the surface of the fixing roller was inspected to check if a plain paper sheet onto which the toner was transferred adhered around the fixing roller, and then the fixability and the releasability were evaluated on the basis of the following criteria.

A (excellent): The adherence of the sheet around the roller was not observed even if a toner amount per unit area of the solid image was 1.8 mg/cm².

B (good): The adherence of the sheet around the roller was observed when the toner amount per unit area of the solid image was not less than 1.5 mg/cm².

C (unacceptable): The adherence of the sheet around the roller was observed when the toner amount per unit area of the solid image was less than 1.5 mg/cm².

The measurement values of the physical properties of the toners and the results of the evaluation are shown in Table 4.

TABLE 4

| | | THF | | | | | Ratios of melt | | | Offset | | |
|---|---|---|---|---|---|---|---|---|---|---|---|---|
| | Resin | insoluble | Melt viscosities η | | | | viscosities | | | Low | High | Fixability and |
| | No. | content | η₉₂ | η₉₅ | η₁₀₀ | η₁₁₀ | A | B | B/A | temperature | temperature | releasability |
| Comparative | U-1 | 3 | 0.135 | 0.097 | 0.034 | 0.009 | 3.995 | 3.675 | 0.920 | A | C | C |
| Example 1 | | | | | | | | | | | | |
| Example 1 | U-2 | 2 | 0.808 | 0.58 | 0.200 | 0.053 | 4.051 | 3.747 | 0.925 | A | A | A |
| Example 2 | U-3 | 5 | 8.760 | 6.3 | 2.200 | 0.595 | 3.982 | 3.697 | 0.928 | A | A | A |
| Comparative | U-4 | 13 | 18.363 | 13 | 4.061 | 0.998 | 4.522 | 4.070 | 0.900 | C | A | A |
| Example 2 | | | | | | | | | | | | |
| Comparative | U-5 | 4 | 0.137 | 0.099 | 0.036 | 0.013 | 3.856 | 2.641 | 0.685 | A | C | C |
| Example 3 | | | | | | | | | | | | |
| Example 3 | U-6 | 4 | 0.166 | 0.12 | 0.044 | 0.019 | 3.752 | 2.383 | 0.635 | A | A | A |
| Example 4 | U-7 | 9 | 13.820 | 9.8 | 3.100 | 1.021 | 4.458 | 3.036 | 0.681 | A | A | A |
| Example 5 | U-8 | 8 | 8.917 | 6.3 | 1.938 | 0.926 | 4.600 | 2.093 | 0.455 | A | A | A |
| Comparative | U-9 | 10 | 17.006 | 12 | 3.656 | 1.641 | 4.651 | 2.228 | 0.479 | C | A | A |
| Example 4 | | | | | | | | | | | | |
| Comparative | U-10 | 12 | 13.563 | 9.8 | 3.528 | 1.994 | 3.845 | 1.769 | 0.460 | C | A | A |
| Example 5 | | | | | | | | | | | | |
| Comparative | U-11 | 9 | 13.600 | 9.8 | 3.467 | 2.057 | 3.922 | 1.686 | 0.430 | C | A | A |
| Example 6 | | | | | | | | | | | | |
| Comparative | P-10 | 6 | 3.024 | 2.1 | 0.560 | 0.084 | 5.400 | 6.685 | 1.238 | A | C | C |
| Example 7 | | | | | | | | | | | | |
| Comparative | P-11 | 6 | 3.475 | 2.5 | 0.874 | 0.232 | 3.975 | 3.776 | 0.950 | A | A | C |
| Example 8 | | | | | | | | | | | | |

In Table 4, the unit of “THF insoluble content” is “Wt %”. The unit of “Melt viscosities” (η₉₂, η₉₅, η₁₀₀ and η₁₁₀) is “×10⁵ Pa·s”. “Ratios of melt viscosities” (A, B and B/A) are dimensionless numbers, and the ratio A and the ratio B are defined as “η₉₂/η₁₀₀” and “η₁₀₀/η₁₁₀”, respectively. In the column of “Low temperature” of “Offset”, the results of the evaluation for the cold offset are shown. In the column of “High temperature” of “Offset”, the results of the evaluation for the hot offset are shown.

As apparent from Table 4, the toners of Examples 1 to 5 suppress both the cold offset and the hot offset and ensure satisfactory fixability and releasability. This is because the toners of Examples 1 to 5 each employ a urethane-modified polyester resin having a melt viscosity η₉₅ of 1.0×10⁴ to 1.0×10⁶ Pa·s at 95° C. and a THF insoluble content of not higher than 10 Wt % as the binder resin, and the ratio B/A between the ratio B (η₁₀₀/η₁₁₀) and the ratio A (η₉₂/η₁₀₀) for the melt viscosities of each of the toners of Examples 1 to 5 is in the range higher than 0.45 and lower than 0.93.

While the present invention has thus been described by way of the embodiments thereof, it should be understood that these embodiments are illustrative of the present invention but not limitative. Modifications of the present invention apparent to those skilled in the art fall within the scope of the present invention as defined by the following claims.

What is claimed is:

1. A toner comprising:
a binder resin; and
a colorant;
the binder resin comprising a urethane-modified polyester resin having a tetrahydrofuran insoluble content of not higher than 10% by weight;
the toner having a melt viscosity η₉₅ of 1.0×10⁴ to 1.0×10⁶ Pa·s at 95±0.2° C.;
the toner having a ratio A (η₉₂/η₁₀₀) of a melt viscosity η₉₂ at 92±0.2° C. to a melt viscosity η₁₀₀ at 100±0.2° C. and a ratio B (η₁₀₀/η₁₁₀) of a melt viscosity η₁₀₀ at 100±0.2° C. to a melt viscosity η₁₁₀ at 110±0.2° C. which satisfy the following expression (i):
0.45<B/A<0.93 (i)

2. A toner as set forth in claim 1, wherein the urethane-modified polyester resin is a resin prepared by melt-kneading a blend of a polyester resin and a diisocyanate-based compound.

3. A toner as set forth in claim 2, wherein the diisocyanate-based compound is present in a proportion of 1 to 10 parts by weight based on 100 parts by weight of the polyester resin in the blend.

4. A toner as set forth in claim 1, wherein the ratio A (η₉₂/η₁₀₀) of the melt viscosity η₉₂ at 92±0.2° C. to the melt viscosity η₁₀₀ at 100±0.2° C. and the ratio B (η₁₀₀/η₁₁₀) of the melt viscosity η₁₀₀ at 100±0.2° C. to the melt viscosity η₁₁₀ at 110±0.2° C. satisfy the following expression (ii):
0.60<B/A<0.92 (ii)

5. A toner as set forth in claim 1, wherein the ratio A (η₉₂/η₁₀₀) of the melt viscosity η₉₂ at 92±0.2° C. to the melt viscosity η₁₀₀ at 100±0.2° C. is 3.0 to 4.8

6. A toner as set forth in claim 1, wherein the ratio B (η₁₀₀/η₁₁₀) of the melt viscosity η₁₀₀ at 100±0.2° C. to the melt viscosity η₁₁₀ at 110±0.2° C. is 1.8 to 4.0.

7. A toner as set forth in claim 1, wherein the melt viscosity η₉₂ of the toner at 92±0.2° C. is 1.09×10⁴ to 1.5×10⁶ Pass.

8. A toner as set forth in claim 1, wherein the melt viscosity η₁₀₀ of the toner at 110±0.2° C. is 4.0×10³ to 3.5×10⁵ Pa·s.

9. A toner as set forth in claim 1, wherein the melt viscosity η₁₁₀ of the toner at 110±0.2° C. is 1.5×10³ to 1.5×10⁵ Pa·s.
